(19) United States
(12) Patent Application Publication
(10) Pub. No.: US 2015/0120715 A1
(43) Pub. Date: Apr. 30, 2015

(54) NON-TRANSITORY COMPUTER READABLE MEDIUM, DOCUMENT RECOMMENDING APPARATUS, AND DOCUMENT RECOMMENDING METHOD

(71) Applicant: FUJI XEROX CO., LTD., Tokyo (JP)

(72) Inventor: Takeshi KUNIMASA, Yokohama-shi (JP)

(73) Assignee: FUJI XEROX CO., LTD., Tokyo (JP)

(21) Appl. No.: 14/301,787

(22) Filed: Jun. 11, 2014

(30) Foreign Application Priority Data
Oct. 30, 2013 (JP) 2013-226007

(51) Int. Cl. G06F 17/30

(52) U.S. Cl. CPC G06F 17/30011
USPC 707/724

(57) ABSTRACT

A non-transitory computer readable medium storing a program causing a computer to execute a process for recommending a document is disclosed. The process includes acquiring current position information of a portable terminal, storing place attribute information, multiple electronic documents, and document attribute information, the place attribute information being information in which positional information and an attribute of a place indicated by the positional information are associated with each other, the document attribute information indicating an attribute of each of the multiple electronic documents, determining an attribute of the current position information on a basis of the current position information and the place attribute information, selecting a recommended document for the portable terminal from the multiple electronic documents, on a basis of the attribute of the current position information and the document attribute information, and causing information indicating the recommended document to be displayed on a display of the portable terminal.

### CROSS-REFERENCE TO RELATED APPLICATIONS

This application is based on and claims priority under 35 USC 119 from Japanese Patent Application No. 2013-226007 filed Oct. 30, 2013.

### BACKGROUND

The present invention relates to a non-transitory computer readable medium, a document recommending apparatus, and a document recommending method.

### SUMMARY

According to an aspect of the invention, there is provided a non-transitory computer readable medium storing a program causing a computer to execute a process for recommending a document, the process including acquiring current position information of a portable terminal, storing place attribute information, multiple electronic documents, and document attribute information, the place attribute information being information in which positional information and an attribute of a place indicated by the positional information are associated with each other, the document attribute information indicating an attribute of each of the multiple electronic documents, determining an attribute of the current position information on a basis of the current position information and the place attribute information, selecting a recommended document for the portable terminal from the multiple electronic documents, on a basis of the attribute of the current position information and the document attribute information, and causing information indicating the recommended document to be displayed on a display of the portable terminal.

### BRIEF DESCRIPTION OF THE DRAWINGS

Exemplary embodiments of the present invention will be described in detail based on the following figures, wherein:

FIG. 1 schematically illustrates a configuration of a document recommending system according to an exemplary embodiment;

FIG. 2 illustrates the data structure of history information;

FIG. 3 illustrates the data structure of place attribute information;

FIG. 4 illustrates the data structure of document attribute information;

FIG. 5 illustrates the data structure of user information;

FIG. 6 is a flowchart illustrating a flow of processing according to a first exemplary embodiment;

FIG. 7 is a flowchart illustrating the details of processing in step S10;

FIG. 8 is a flowchart illustrating the details of processing in step S14;

FIG. 9 is a flowchart illustrating a flow of processing according to a second exemplary embodiment;

FIG. 10 is a flowchart illustrating the details of processing in step S60;

FIG. 11 is a flowchart illustrating a flow of processing according to a third exemplary embodiment, and illustrates the details of processing in step S60;

FIG. 12 is a flowchart illustrating a flow of processing according to a fourth exemplary embodiment, and illustrates the details of processing in step S60; and

FIG. 13 is a flowchart illustrating a flow of processing according to a fifth exemplary embodiment.

### DETAILED DESCRIPTION

Hereinafter, a document recommending program and a document recommending apparatus according to exemplary embodiments of the present invention will be described. It is to be understood that the present invention is not limited to the exemplary embodiments described below.

### First Exemplary Embodiment

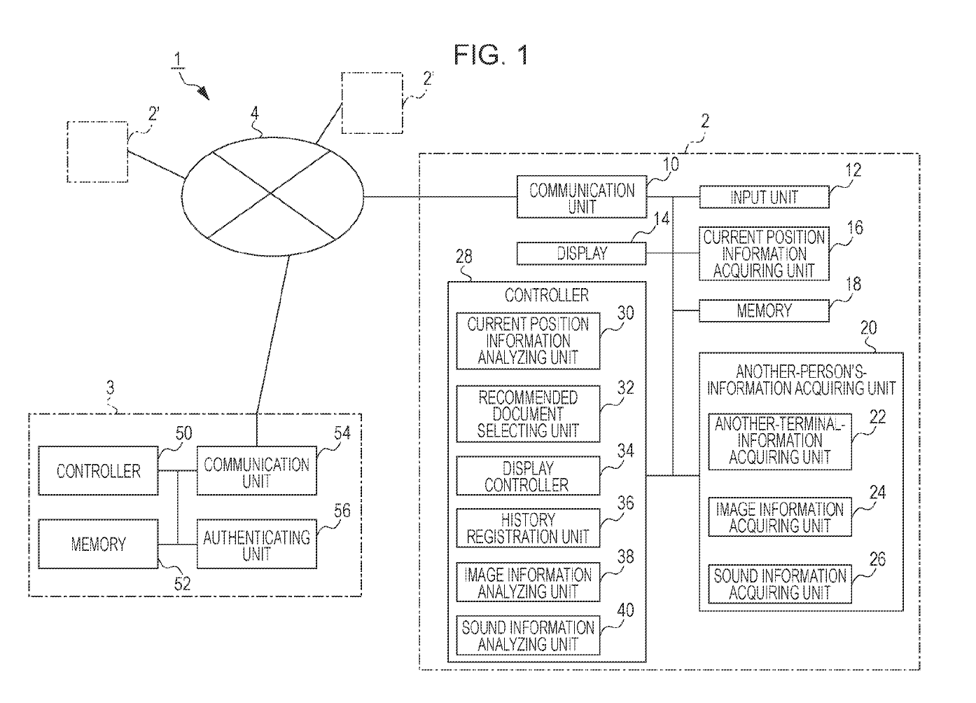

FIG. 1 schematically illustrates a configuration of a document recommending system 1 according to a first exemplary embodiment. The document recommending system 1 includes a portable terminal 2, a document management server 3, and a network 4 that connects the portable terminal 2 and the document management server 3. The document recommending system 1 may include multiple portable terminals 2. A configuration of another portable terminal 2′ is the same as that of the portable terminal 2.

The portable terminal 2 is, for example, a portable terminal such as a smartphone or a mobile PC. The portable terminal 2 includes a communication unit 10, an input unit 12, a display 14, a current position information acquiring unit 16, a memory 18, an another-person's-information acquiring unit 20, and a controller 28. The portable terminal 2 performs manipulations such as copy, move, edit, and view with respect to an electronic document downloaded from the document management server 3 or an electronic document stored in the memory 18. Alternatively, the portable terminal 2 may transmit a manipulation instruction with respect to an electronic document stored in the document management server 3.

The communication unit 10 is, for example, a wireless LAN device. The communication unit 10 is used to communicate with the document management server 3, another portable terminal 2′, or the like via the network 4. Alternatively, the communication unit 10 may be a Bluetooth® device or an infrared device, or may be a unit that performs near-field radio communication with another portable terminal 2′ existing near the portable terminal 2.

The input unit 12 is, for example, a keyboard or a touch panel. The input unit 12 is used for inputting an instruction or the like from the user of the portable terminal 2 to the portable terminal 2.

The display 14 is a unit for displaying, for example, information about processing in the portable terminal 2. In a case where the input unit 12 is a touch panel, the display 14 displays a button, a software keyboard, or the like as the input unit 12.

The current position information acquiring unit 16 is, for example, a global positioning system (GPS) receiver. The current position information acquiring unit 16 acquires the current position information of the portable terminal 2 as latitude/longitude coordinates. In addition to the latitude/longitude, the current position information acquiring unit 16 may also acquire height information indicating the altitude (for example, the altitude above sea level) of the current position of the portable terminal 2.

The memory 18 is, for example, a ROM, a RAM, or a hard disk. The memory 18 stores data and the like to be processed in the portable terminal 2. Further, the memory 18 stores a program for causing the portable terminal 2 to function as a document recommending apparatus according to the first exemplary embodiment.

The memory 18 accumulates and stores history information. The history information is information related to electronic documents manipulated by the portable terminal 2 in the past.

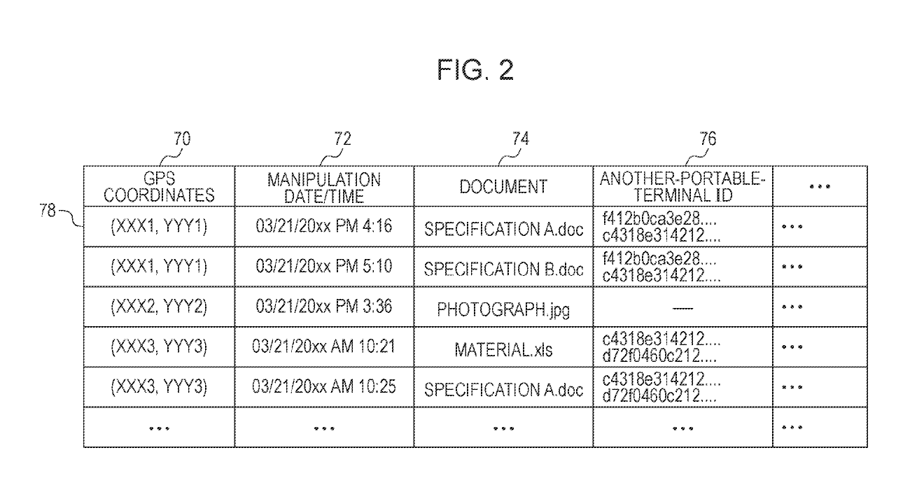

FIG. 2 illustrates the data structure of history information. The history information is represented by a table that includes a GPS coordinate column 70, a manipulation date/time column 72, a document column 74, and an another-portable-terminal ID column 76. The GPS coordinate column 70 indicates the positional information of the portable terminal 2 at the time when an electronic document is manipulated. The manipulation date/time column 72 indicates the date/time when an electronic document is manipulated. The document column 74 indicates an electronic document that has been manipulated. The another-portable-terminal ID column 76 indicates the identification ID of another portable terminal 2′ existing near the portable terminal 2 at the time when an electronic document is manipulated. These pieces of information are stored in the table in association with each other. A portable terminal ID is a code that uniquely identifies a portable terminal. A portable terminal ID is stored in a memory of each portable terminal.

For example, a record 78 indicates that the electronic document “Specification A.doc” is manipulated by the portable terminal 2 at the position “(XXX1, YYY1)” at the date/time “03/21/20xx PM 4:16”, and that another portable terminal 2′ with the portable terminal ID “f412b0ca3e28 . . . ” and another portable terminal 2′ with the portable terminal ID “c4318e314212 . . . ” exist near the portable terminal 2 at the time of the manipulation. A method of identifying another terminal 2′ existing near the portable terminal 2 at the time of manipulation will be described later.

The memory 18 stores place attribute information indicating the attributes of a place indicated by positional information. Place attribute information includes the attributes of a place indicated by positional information included in the GPS coordinate column 70 of history information.

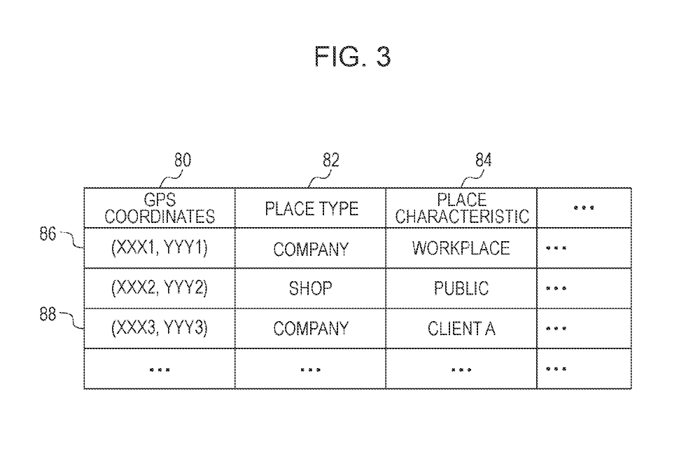

FIG. 3 illustrates the data structure of place attribute information. The place attribute information is represented by a table that includes a GPS coordinate column 80, a place type column 82, and a place characteristic column 84. The GPS coordinate column 80 indicates positional information. The place type column 82 indicates the type of a place indicated by positional information. The place characteristic column 84 indicates the characteristic of a place indicated by positional information. These pieces of information are stored in the table in association with each other. The portable terminal 2 acquires a place type and a place characteristic corresponding to positional information from information provided by an existing map service.

The type of a place is information indicating an objective attribute of the place. For example, this information indicates “Company”, “Shop”, or the like. The characteristic of a place is information indicating a subjective attribute of the place, that is, information indicating what meaning the place has for the user of the portable terminal 2. For example, this information indicates “Workplace”, “Public”, or “Client A”.

For example, a record 86 indicates that the place type of a place indicated by the positional information “(XXX1, YYY1)” is “Company”, and that its place characteristic is “Workplace” for the user of the portable terminal 2.

The memory 18 stores document attribute information indicating the attributes of electronic documents. In the first exemplary embodiment, document attribute information includes the attributes of each electronic document included in the document column 74 of history information. However, document attribute information may include the attributes of electronic documents that are stored in the memory 18 of the portable terminal 2 but not included in history information, or the attributes of electronic documents that are stored in the document management server 3 but not included in history information.

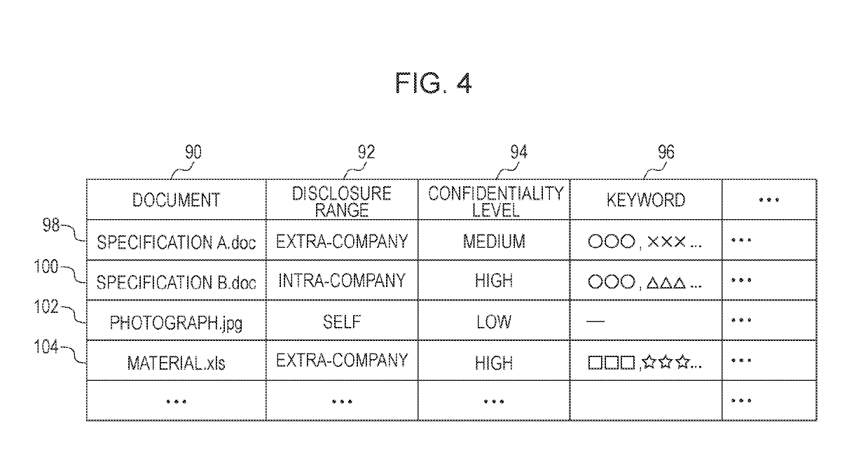

FIG. 4 illustrates the data structure of document attribute information. The document attribute information is represented by a table that includes a document column 90, a disclosure range column 92, a confidentiality level column 94, and a keyword column 96. The document column 90 indicates an electronic document. The disclosure range column 92 indicates the range of disclosure allowed for an electronic document. The confidentiality level column 94 indicates the confidentiality level of an electronic document. The keyword column 96 indicates word(s) representing the contents of an electronic document. These pieces of information are stored in the table in association with each other. The disclosure range, the confidentiality level, and the keyword included in document attribute information are set by the user of the portable terminal 2 and stored into the memory 18. Because no keyword is used in the first exemplary embodiment, document attribute information may not have the keyword column 96.

For example, a record 98 indicates that for the electronic document “Specification A.doc”, the disclosure range is “Extra-company”, and the confidentiality level is “Medium”, and that “◯◯◯” and “×××” are included as keywords representing the contents of the electronic document “Specification A.doc”.

The memory 18 stores user information indicating the attributes of a user of another portable terminal 2′. User information includes the attributes of a user of another portable terminal 2′ indicated by a portable terminal ID included in the another-portable-terminal ID column 76 of history information.

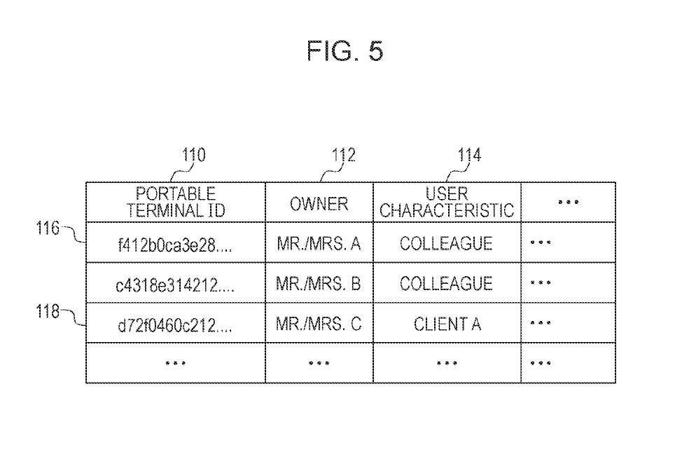

FIG. 5 illustrates the data structure of user information. The user information is represented by a table that includes a portable terminal ID column 110, an owner column 112, and a user characteristic column 114. The portable terminal ID column 110 indicates a portable terminal ID. The owner column 112 indicates the owner of a portable terminal. The user characteristic column 114 indicates the characteristic of an owner. These pieces of information are stored in the table in association with each other. In a case where the portable terminal 2 is a smartphone or the like, user information is managed as registration information of the portable terminal 2 such as an address book. Alternatively, a user list in which users of the document recommending system 1 and their attributes are associated with each other may be stored in the document management server 3 in advance as user information, and the portable terminal 2 may acquire the user information from the document management server 3.

A user characteristic is information indicating a subjective attribute of the owner of another portable terminal 2′ as viewed from the user of the portable terminal 2, that is, information indicating the relationship between the user of the portable terminal 2 and this owner.

For example, a record 116 indicates that the owner of another portable terminal 2′ indicated by the portable terminal ID “f412b0ca3e28 . . . ” is “Mr./Mrs. A”, and that the user characteristic of “Mr./Mrs. A” is “Colleague” as viewed from the user of the portable terminal 2.

User information may include the attributes of another portable terminal 2′ indicated by a portable terminal ID not included in history information. For example, user information may include information about each person registered in the document management server as a user of the document recommending system. User information may also include information such as face image identification information in which each user of the document recommending system 1 and face image information of the corresponding user are associated with each other, or voice identification information in which each user of the document recommending system 1 and sound information including the voice of the corresponding user are associated with each other.

The another-person's-information acquiring unit 20 includes an another-terminal-information acquiring unit 22, an image information acquiring unit 24, and a sound information acquiring unit 26.

The another-terminal-information acquiring unit 22 identifies another portable terminal 2′ by performing near-field radio communication with the other portable terminal 2′ by the communication unit 10, and acquires a portable terminal ID stored in the memory of the other portable terminal 2′. The another-terminal-information acquiring unit 22 also acquires history information, place attribute information, document attribute information, and user information stored in the other portable terminal 2′.

The image information acquiring unit 24 is, for example, a camera, and acquires an image or video of an area near the portable terminal 2.

The sound information acquiring unit 26 is, for example, a microphone, and acquires sound in an area near the portable terminal 2.

The controller 28 is, for example, the CPU of the portable terminal 2. The controller 28 includes a current position information analyzing unit 30, a recommended document selecting unit 32, a display controller 34, a history registration unit 36, an image information analyzing unit 38, and a sound information analyzing unit 40.

The current position information analyzing unit 30 acquires the attributes of the current position of the portable terminal 2, on the basis of the current position information of the portable terminal 2 acquired by the current position information acquiring unit 16, and place attribute information read from the memory 18. For example, in a case where the current position information of the portable terminal 2 acquired by the current position information acquiring unit 16 is “(XXX1, YYY1)”, the current position information analyzing unit 30 references the record 86 of place attribute information illustrated in FIG. 3, and acquires the place type “Company” and the place characteristic “Workplace”.

The recommended document selecting unit 32 selects at least one recommended document (hereinafter simply “recommended documents” for convenience) from electronic documents included in document attribute information, on the basis of the attributes of the current position of the portable terminal 2 acquired by the current position information analyzing unit 30, and document attribute information read from the memory 18. Details of a recommended document selection process executed in the recommended document selecting unit 32 will be described later with reference to a flowchart. A recommended document means an electronic document that is determined suitable as document to be manipulated by the user of the portable terminal 2 at the current position of the portable terminal 2.

The display controller 34 causes the display 14 to display information indicating the recommended documents selected by the recommended document selecting unit 32. For example, the display controller 34 causes the display 14 to display a list of recommended documents.

The history registration unit 36 registers history information when an electronic document is manipulated on the portable terminal 2, by associating the following pieces of information with each other: the current position information of the portable terminal 2 at the time when the electronic document is manipulated; the date/time when the electronic document is manipulated; the electronic document that has been manipulated; and the identification ID of another portable terminal 2′ existing near the portable terminal 2 at the time when the electronic document is manipulated.

The image information analyzing unit 38 analyzes image information acquired by the image information acquiring unit 24. For example, the image information analyzing unit 38 executes processing such as extracting face image information by detecting a face portion included in image information by using an existing face recognition technique.

The sound information analyzing unit 40 analyzes sound information including a voice acquired by the sound information acquiring unit 26. For example, the sound information analyzing unit 40 executes processing such as analyzing the frequency spectrum of a voice included in sound information. Further, by using an existing sound recognition technique, the sound information analyzing unit 40 extracts a word from the sound information acquired by the sound information acquiring unit 26.

The document management server 3 is connected so as to be able to communicate with the portable terminal 2 and another portable terminal 2′ via the network 4. The document management server 3 includes a controller 50 such as a CPU, a memory 52 such as a ROM, RAM, or a hard disk, a communication unit 54 such as a LAN card for connecting to the network 4, and an authenticating unit 56 that authenticates the user of the document management server 3.

The memory 52 stores electronic documents that can be manipulated from the portable terminal 2 and another portable terminal 2′. The authenticating unit 56 transmits image data that prompts entry of a user ID and a password to the portable terminal 2 when, for example, a connection request is made from the portable terminal 2. Then, the authenticating unit 56 authenticates the user on the basis of the user ID and the password entered by the user by using the input unit 12 of the portable terminal 2.

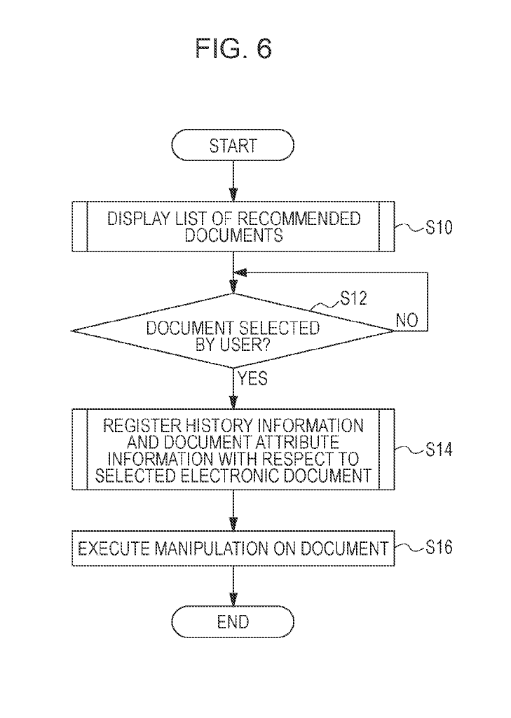

Hereinafter, a flow of processing in the portable terminal 2 according to the first exemplary embodiment will be described. FIG. 6 is a flowchart illustrating a flow of processing according to the first exemplary embodiment.

In step S10, when the portable terminal 2 receives a start command for a document editing application or the like, the recommended document selecting unit 32 selects recommended documents for the user of the portable terminal 2, and the display controller 34 causes the display 14 to display a list of the selected recommended documents.

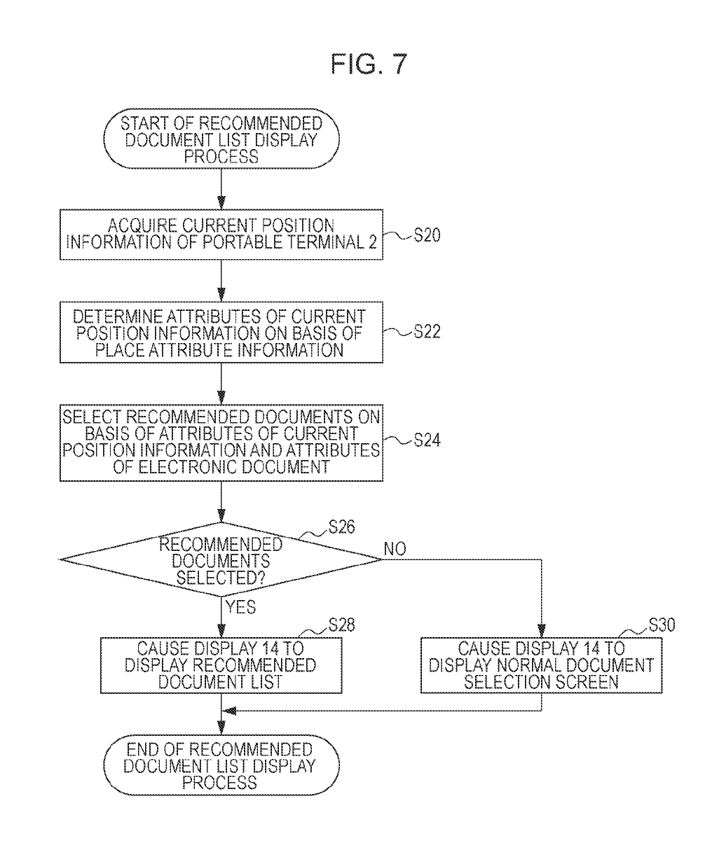

FIG. 7 is a flowchart illustrating the details of processing in step S10.

In step S20, the current position information acquiring unit 16 acquires current position information indicating the current position of the portable terminal 2. In the present example, it is supposed that “(XXX3, YYY3)” is acquired as the current position information of the portable terminal 2.

In step S22, the current position information analyzing unit 30 acquires the attributes of the place indicated by the current position information, on the basis of the current position information of the portable terminal 2 acquired from the current position information acquiring unit 16, and place attribute information read from the memory 18. In the present example, on the basis of the current position information “(XXX3, YYY3)” acquired by the current position information acquiring unit 16, the recommended document selecting unit 32 references a record 88 of place characteristic information, and determines that the place type of the current position information is “Company” and that its place characteristic is “Client A”.

In step S24, the recommended document selecting unit 32 selects recommended documents for the portable terminal 2, on the basis of the attributes of a place indicated by the current position information determined by the current position information analyzing unit 30, and document attribute information read from the memory 18.

In the present example, the recommended document selecting unit 32 selects recommended documents on the basis of the place characteristic included in place attribute information and the disclosure range included in document attribute information. In this case, on the basis of the determined place characteristic “Client A”, the recommended document selecting unit 32 determines that electronic documents whose disclosure range is “Extra-company” are to be recommended to the user of the portable terminal 2. Then, the recommended document selecting unit 32 references the disclosure range column 92 of the document attribute information, and extracts records 98 and 104 whose disclosure range is “Extra-company”. Further, the recommended document selecting unit 32 selects the electronic documents “Specification A.doc” and “Material.xls”, which are included in the document column 90 of each of the records 98 and 104, as recommended documents.

The recommended document selecting unit 32 may select recommended documents on the basis of the place characteristic and the confidentiality level. In this case, in a case where it is known in advance that “Client A” is a trustable client, the recommended document selecting unit 32 may be configured to determine that electronic documents with confidentiality levels lower than or equal to “Medium” are allowed to be used for “Client A”. Then, the recommended document selecting unit 32 references the confidentiality level column 94 of the document attribute information, and extracts records 98 and 102 that have confidentiality levels lower than or equal to “Medium”. Further, the recommended document selecting unit 32 selects the electronic documents “Specification A.doc” and “Photograph.jpg”, which are included in the document column 90 of each of the records 98 and 102, as recommended documents.

As described above, among pieces of information included in the attributes of current position information and document attribute information, on the basis of which piece of information the recommended document selecting unit 32 selects recommended documents can be set as appropriate by the user of the portable terminal 2.

Attribute relationship information is stored in the memory 18. In attribute relationship information, information included in place attribute information and information included in document attribute information are associated with each other. Attribute relationship information includes, for example, information in which a place characteristic “Client A” included in place attribute information and a disclosure range “Extra-company” included in document attribute information are associated with each other. On the basis of the attribute relationship information, for example, the recommended document selecting unit 32 determines that electronic documents whose disclosure range is “Extra-company” are to be selected as recommended documents in a case where the determined place characteristic is “Client A”. The association of various pieces of information with each other in the attribute relationship information is performed by the user of the portable terminal 2 in advance.

In step S26, the display controller 34 determines whether or not recommended documents have been selected by the recommended document selecting unit 32. In a case where it is determined that recommended documents have been selected, the processing proceeds to step S28, and in a case where it is determined that recommended documents have not been selected, the processing proceeds to step S30.

In step S28, the display controller 34 causes the display 14 to display information indicating recommended documents, for example, a list of recommended documents. In the present example, the files names of “Specification A.doc” and “Material.xls” selected as recommended documents are displayed as a list.

In step S30, because recommended documents have not been selected, the display controller 34 does not cause the display 14 to display information indicating recommended documents but causes the display 14 to display, for example, a normal electronic document selection screen of an application for which a start command has been received.

When step S28 or S30 is finished, the recommended document display process ends, and the processing proceeds to step S12 in FIG. 6.

In step S12, the history registration unit 36 determines whether or not an electronic document to be manipulated has been selected by the user of the portable terminal 2. In a case where an electronic document has been selected, the processing proceeds to step S14, and in a case where an electronic document has not been selected, whether or not an electronic document has been selected is determined again (that is, the history registration unit 36 waits on standby for selection of an electronic document). In the present example, it is supposed that “Specification A.doc” has been selected by the user.

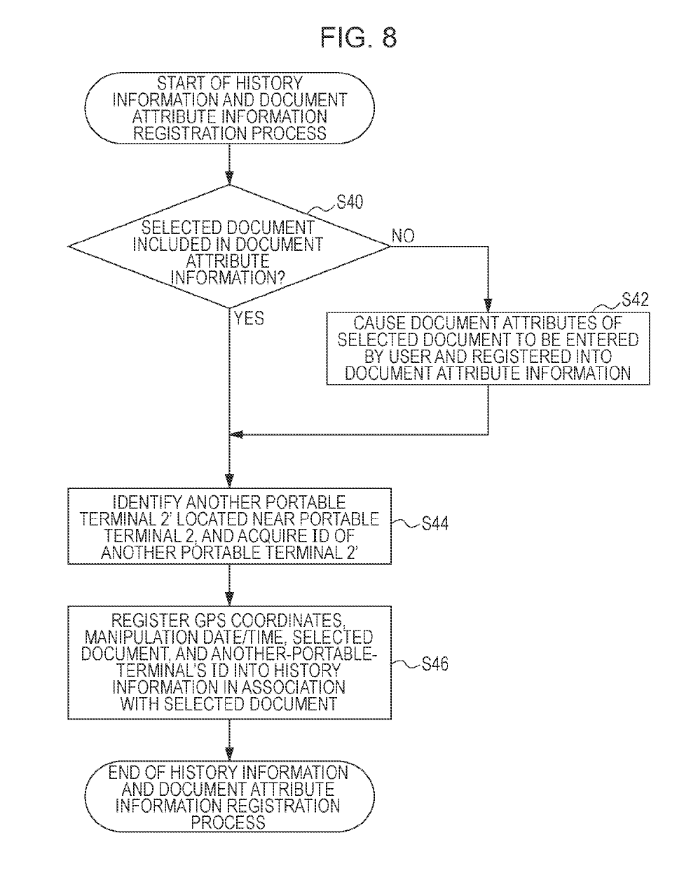

In step S14, the history registration unit 36 registers history information and document attribute information with respect to the selected electronic document. FIG. 8 is a flowchart illustrating the details of processing in step S14.

In step S40, the history registration unit 36 determines whether or not the electronic document selected in step S12 is included in document attribute information. In a case where the selected electronic document is included in document attribute information, the processing proceeds to step S44, and in a case where the selected electronic document is not included in document attribute information, the processing proceeds to step S42.

In step S42, the history registration unit 36 causes the user of the portable terminal 2 to enter the document attributes of the selected document, that is, disclosure range, confidentiality level, keywords, and the like, and the history registration unit 36 adds the entered attributes to the document attribute information of the selected document.

In step S44, the another-terminal-information acquiring unit 22 identifies another portable terminal 2′ existing near the portable terminal 2, and acquires, from the other portable terminal 2′ that has been identified, the portable terminal ID of the other portable terminal 2′.

In step S46, the history registration unit 36 registers GPS coordinates, manipulation date/time, and another-portable-terminal's ID into history information in association with the selected electronic document. In the present example, the history registration unit 36 adds, to history information, a record in which the value of the GPS coordinate column 70 represents the current position information of the portable terminal 2 at the time when “Specification A.doc” is selected in step S12, the value of the manipulation date/time column 72 represents the date/time at the time when “Specification A.doc” is selected in step S12, the value of the document column 74 represents information indicating the electronic document “Specification A.doc”, and the value of the another-portable-terminal ID column 76 represents the portable terminal ID of the other portable terminal 2′ acquired in step S40.

When the processing in S46 is finished, the registration process of history information and document attribute information ends, and the processing proceeds to step S16 illustrated in FIG. 6.

In step S16, on the portable terminal 2, the controller 28 executes a manipulation with respect to the electronic document selected in step S12, in accordance with a user's instruction.

In the first exemplary embodiment, document attribute information includes electronic documents included in the document column 74 of history information, and the recommended document selecting unit 32 selects recommended documents from the electronic documents included in history information, that is, electronic documents that have been manipulated by the portable terminal 2 in the past. However, as described above, document attribute information may include information related to electronic documents not included in history information, in which case recommended documents may be selected from electronic documents not included in history information.

Alternatively, recommended documents may be selected from only some of electronic documents included in history information. For example, the current position information of the portable terminal 2, and positional information (past position information) included in history information may be referenced, and recommended documents may be selected from electronic documents in the history information which are each associated with past position information indicating a position near a position indicated by the current position information of the portable terminal 2.

Further, as described above, the another-terminal-information acquiring unit 22 is able to acquire place attribute information, document attribute information, and the like possessed by another portable terminal 2′. Thus, the recommended document selecting unit 32 may select recommended documents on the basis of place attribute information and document attribute information acquired from another portable terminal 2′.

For example, in a case where recommended documents are to be selected in a place not included in the place attribute information of the portable terminal 2, it is not possible to acquire the attributes of the place from information possessed by the portable terminal 2 alone. In such a case, if another portable terminal 2′ possesses place attribute information including the attributes of the place, the portable terminal 2 acquires the attributes of the place on the basis of the place attribute information possessed by the other portable terminal 2′.

Electronic documents not included in the document attribute information of the portable terminal 2 may not serve as recommended documents. In this regard, however, by acquiring document attribute information possessed by another portable terminal 2′, recommended documents may be selected also from electronic documents included in the document attribute information of the other portable terminal 2′.

In the first exemplary embodiment, history information, place attribute information, document attribute information, and user information are stored in the memory 18 of the portable terminal 2. However, these pieces of information may be stored in the memory 52 of the document management server 3. Further, electronic documents to be manipulated may be stored in either one of the memory 18 of the portable terminal 2 and the memory 52 of the document management server 3. The same applies to multiple exemplary embodiments described below.

### Second Exemplary Embodiment

In a second exemplary embodiment, the recommended document selecting unit 32 determines a person existing near the portable terminal 2, and selects recommended documents on the basis of the attributes of the person existing near the portable terminal 2. In the following exemplary embodiments from the second exemplary embodiment onward, the general configuration of the document recommending system 1 is the same as that according to the first exemplary embodiment. Further, the second exemplary embodiment differs from the first exemplary embodiment only in the processing of step S24, and is the same as the first exemplary embodiment in the processing of other steps. Therefore, a description of features that have been already described above will be omitted.

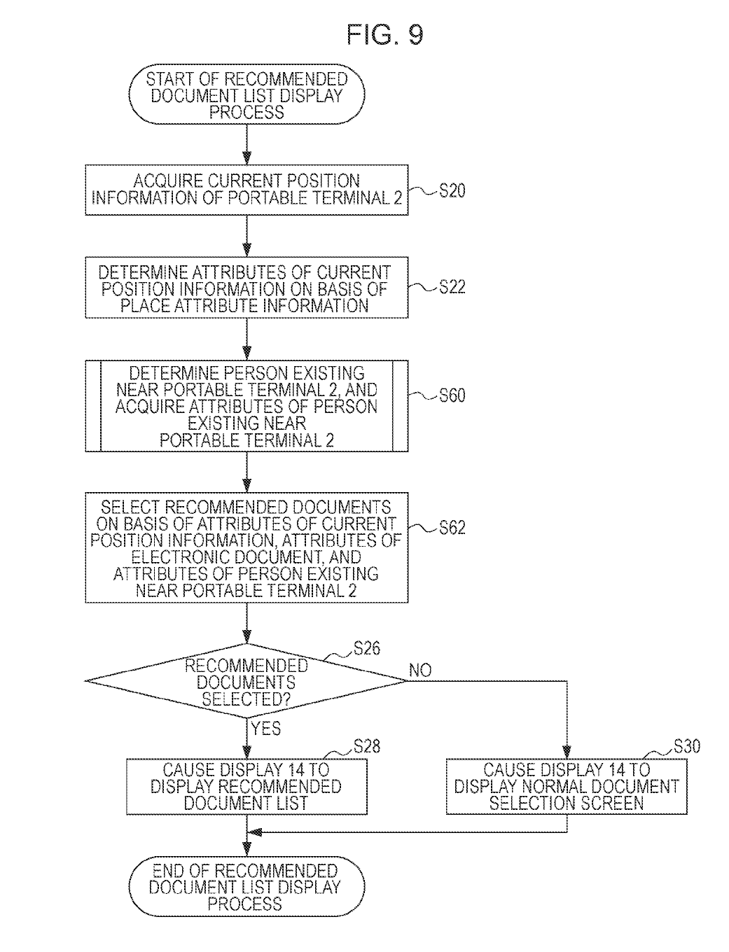

FIG. 9 is a flowchart illustrating a flow of processing in the second exemplary embodiment.

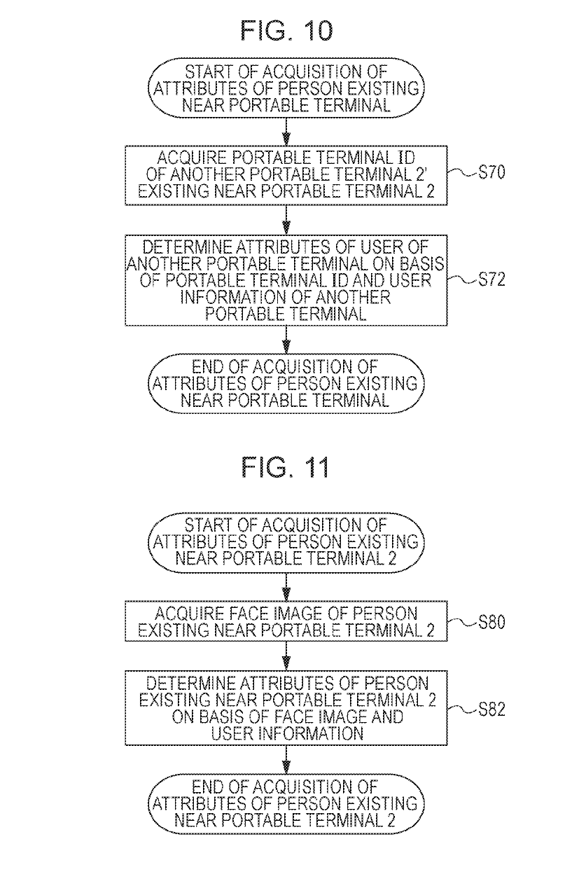

In step S60, the recommended document selecting unit 32 determines a person existing near the portable terminal 2, and acquires the attributes of the person existing near the portable terminal 2. FIG. 10 is a flowchart illustrating the details of processing in step S60.

In step S70, the another-terminal-information acquiring unit 22 identifies another portable terminal 2′ existing near the portable terminal 2, and acquires the portable terminal ID of the other portable terminal 2′. As another portable terminal 2′ existing near the portable terminal 2, the another-terminal-information acquiring unit 22 identifies another portable terminal 2′ that is able to communicate with the portable terminal 2 via near-field radio communication. In the present example, it is supposed that the acquired portable terminal ID of the other portable terminal 2′ is “d72f0460c212 . . . ”.

In step S72, the recommended document selecting unit 32 reads user information from the memory 18, and determines the attributes of the user of the other portable terminal 2′ identified in step S70. In the present example, the portable terminal ID “d72f0460c212 . . . ” has been acquired in step S70. Accordingly, the recommended document selecting unit 32 references a record 118 of the user information illustrated in FIG. 5, fictitiously identifies the person existing near the portable terminal 2 as “Mr./Mrs. C”, and determines an attribute of the person existing near the portable terminal 2 as “Client A”. In a case where user information has attributes other than the owner and the user characteristic, other attributes may be acquired.

In step S62 illustrated in FIG. 9, the recommended document selecting unit 32 selects recommended documents on the basis of the attributes of the place indicated by the current position information of the portable terminal 2 determined in step S22, document attribute information read from the memory 18, and the attributes of the person existing near the portable terminal 2 determined in step S72.

For example, the recommended document selecting unit 32 selects recommended documents on the basis of the place characteristic included in place attribute information, the disclosure range included in document attribute information, and the user characteristic included in user information. In this case, as in the first exemplary embodiment, on the basis of the place characteristic “Client A” determined in step S22 and the disclosure range column 92 of document attribute information, the recommended document selecting unit 32 first extracts the records 98 and 104 whose disclosure range is “Extra-company”. In the second exemplary embodiment, further, on the basis of the user characteristic “Client A” determined in step S72, the recommended document selecting unit 32 determines that, for example, electronic documents whose security level is other than “High” are to be recommended. Then, from the records 98 and 104 previously extracted, the recommended document selecting unit 32 extracts the record 98 whose confidentiality level is other than “High”. Then, the recommended document selecting unit 32 selects the electronic document “Specification A.doc” included in the document column 90 of the record 98 as a recommended document.

As in the first exemplary embodiment, among pieces of information included in user information, on the basis of which piece of information the recommended document selecting unit 32 selects recommended documents can be set as appropriate by the user of the portable terminal 2. Further, the disclosure range or confidentiality level suited for each individual user characteristic (for example, the fact that the confidentiality level suited for the user characteristic “Client A” is other than “High”) is included in attribute relationship information.

In the second exemplary embodiment as well, recommended documents may be selected from only some of electronic documents included in history information. For example, the identification ID of another portable terminal 2′ currently existing near the portable terminal 2 may be referenced, and recommended documents may be selected from electronic documents in the history information which are associated with the identification ID of the other portable terminal 2′ currently existing near the portable terminal 2.

### Third Exemplary Embodiment

In a third exemplary embodiment, as in the second exemplary embodiment, recommended documents are selected on the basis of the attributes of a person existing near the portable terminal 2. However, the method of determining a person existing near the portable terminal 2 differs from the second exemplary embodiment. The third exemplary embodiment differs from the second exemplary embodiment only in the processing of step S60, and is the same as the second exemplary embodiment in the processing of other steps. Therefore, a description of features that have been already described above will be omitted.

FIG. 11 is a flowchart illustrating a flow of processing in the third exemplary embodiment, and illustrates the details of processing in step S60.

In step S80, the image information acquiring unit 24 acquires an image or video including the face image of a person existing near the portable terminal 2. Further, the image information analyzing unit 38 extracts a human face image by an existing face recognition technique from the image or video including the face image which have been acquired by the image information acquiring unit 24.

In the third exemplary embodiment, user information includes face image identification information in which each user of the document recommending system 1, and the face image information of the corresponding user are associated with each other. In step S82, the recommended document selecting unit 32 reads user information from the memory 18, and determines the user associated with the face image detected in step S80. Then, the recommended document selecting unit 32 acquires the attributes of the determined user.

For example, in a case where the user associated with the face image detected in step S80 is “Mr./Mrs. C”, the recommended document selecting unit 32 runs a search on the owner column 112 of the user information illustrated in FIG. 5 with “Mr./Mrs. C” as a key, and extracts the record 118. Then, the recommended document selecting unit 32 acquires the user information “Client A” in the record 118, and determines “Client A” as an attribute of the person existing near the portable terminal 2.

### Fourth Exemplary Embodiment

In the fourth exemplary embodiment, as in the second exemplary embodiment, recommended documents are selected on the basis of the attributes of a person existing near the portable terminal 2. However, the method of determining a person existing near the portable terminal 2 differs from the second and third exemplary embodiments. The fourth exemplary embodiment differs from the second exemplary embodiment only in the processing of step S60, and is the same as the second exemplary embodiment in the processing of other steps. Therefore, a description of features that have been already described above will be omitted.

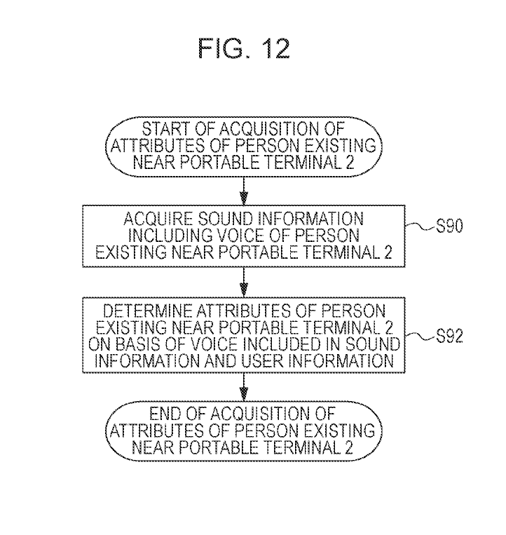

FIG. 12 is a flowchart illustrating a flow of processing in the fourth exemplary embodiment, and illustrates the details of processing in step S60.

In step S90, the sound information acquiring unit 26 acquires sound information including the voice of a person existing near the portable terminal 2. Further, the sound information analyzing unit 40 analyzes the frequency spectrum of the voice included in the sound information acquired by the sound information acquiring unit 26.

In the fourth exemplary embodiment, user information includes voice identification information in which each user of the document recommending system 1, and sound information including the voice of the corresponding user are associated with each other. In the voice recognition information, for example, a user and the frequency spectrum of the voice of the user are associated with each other. In step S92, the recommended document selecting unit 32 reads user information from the memory 18, and determines the user associated with the frequency spectrum of the voice analyzed in step S90. Then, the recommended document selecting unit 32 acquires the attributes of the determined user.

For example, in a case where the user associated with the frequency spectrum of the voice detected in step S90 is “Mr./Mrs. C”, the recommended document selecting unit 32 runs a search on the owner column 112 of the user information illustrated in FIG. 5 with “Mr./Mrs. C” as a key, and extracts the record 118. Then, the recommended document selecting unit 32 acquires the user information “Client A” in the record 118, and determines “Client A” as an attribute of the person existing near the portable terminal 2.

### Fifth Exemplary Embodiment

In a fifth exemplary embodiment, a word is extracted from the sound acquired by the sound information acquiring unit 26, and the recommended document selecting unit 32 selects recommended documents on the basis of the extracted word and a keyword included in document attribute information. The fifth exemplary embodiment differs from the first exemplary embodiment only in the processing of step S24, and is the same as the first exemplary embodiment in the processing of other steps. Therefore, a description of features that have been already described above will be omitted.

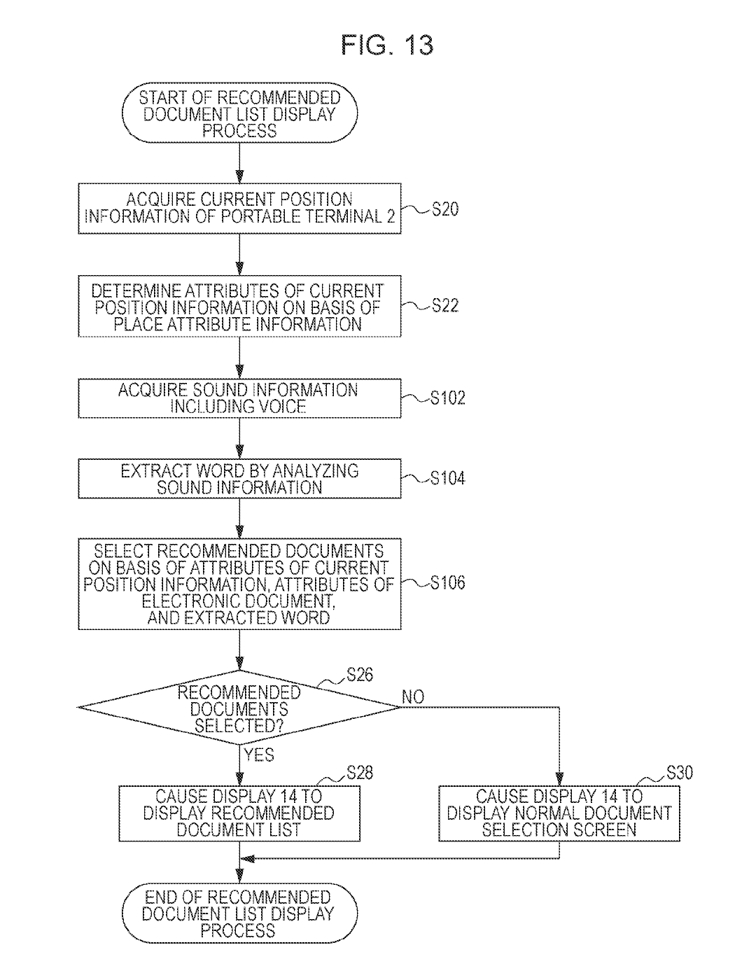

FIG. 13 is a flowchart illustrating a flow of processing according to the fifth exemplary embodiment.

In step S102, the sound information acquiring unit 26 acquires sound information including a voice.

In step S104, the sound information analyzing unit 40 extracts a word from the sound information acquired by the sound information acquiring unit 26, by using an existing sound recognition technique. In the fifth exemplary embodiment, it is supposed that a word “□□□” is extracted from the sound information.

In step S106, the recommended document selecting unit 32 selects recommended documents on the basis of the attributes of a place indicated by the current position information of the portable terminal 2 which have been determined in step S22, document attribute information read from the memory 18, and the word extracted in step S104.

For example, the recommended document selecting unit 32 selects recommended documents on the basis of the place characteristic included in place attribute information, the disclosure range included in document attribute information, and the word extracted from sound information. In this case, as in the first exemplary embodiment, on the basis of the place characteristic “Client A” determined in step S22 and the disclosure range column 92 of document attribute information, the recommended document selecting unit 32 first extracts the records 98 and 104 whose disclosure range is “Extra-company”. In the fifth exemplary embodiment, further, on the basis of the word “ [symbol] ” extracted in step S104, the recommended document selecting unit 32 determines that electronic documents that include “ [symbol] ” as a keyword are to be recommended. Then, from the records 98 and 104 previously extracted, the recommended document selecting unit 32 extracts the record 104 that includes “ [symbol] ” as a keyword. Then, the recommended document selecting unit 32 selects the electronic document “Material.xls” included in the document column 90 of the record 104 as a recommended document.

In the above-mentioned example, an electronic document is selected as a recommended document in a case where the word extracted in step S104 matches a word included in the keyword column 96 of the document attribute information of the electronic document. However, an electronic document may be selected as a recommended document also in a case where an extracted word and a word included in the keyword column 96 are similar. For example, the following configuration may be employed. That is, a thesaurus dictionary is stored in the memory 18 in advance, ranges within which words are considered similar are determined on the basis of the thesaurus dictionary, and in a case where it is determined that an extracted word is similar to a keyword included in document attribute information, an electronic document associated with the keyword is selected as a recommended document.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for recommending a document, the process comprising:
acquiring current position information of a portable terminal;
storing place attribute information, a plurality of electronic documents, and document attribute information, the place attribute information being information in which positional information and an attribute of a place indicated by the positional information are associated with each other, the document attribute information indicating an attribute of each of the plurality of electronic documents;
determining an attribute of the current position information on a basis of the current position information and the place attribute information;
selecting a recommended document for the portable terminal from the plurality of electronic documents, on a basis of the attribute of the current position information and the document attribute information; and
causing information indicating the recommended document to be displayed on a display of the portable terminal.

2. The non-transitory computer readable medium according to claim 1, wherein:
the process further comprises acquiring another person's information, the another person's information being information related to a person existing near the portable terminal;
the storing includes storing user information in which the another person's information and an attribute of a person determined by the another person's information are associated with each other; and
the selecting of the recommended document includes determining a person existing near the portable terminal on a basis of the another person's information and the user information, and selecting the recommended document for the portable document from the plurality of electronic documents on a basis of an attribute of the determined person existing near the portable terminal.

3. The non-transitory computer readable medium according to claim 2, wherein:
the another person's information is information that identifies another portable terminal existing near the portable terminal; and
in the user information, the other portable terminal and an attribute of a user of the other portable terminal are associated with each other.

4. The non-transitory computer readable medium according to claim 2, wherein the another person's information is face image information of a person existing near the portable terminal.

5. The non-transitory computer readable medium according to claim 2, wherein the another person's information is sound information including a voice of a person existing near the portable terminal.

6. The non-transitory computer readable medium according to claim 1, wherein:
the storing includes storing history information in which an electronic document previously used by the portable terminal and past position information are associated with each other, the past position information being positional information of the portable telephone at a time when the electronic document is used; and
the selecting of the recommended document includes selecting the recommended document for the portable terminal from at least one electronic document that is associated with the past position information indicating a position near a position indicated by the current position information.

7. The non-transitory computer readable medium according to claim 6, wherein:
the process further comprises identifying another portable terminal existing near the portable terminal, and acquiring the history information of the other portable terminal; and
the selecting of the recommended document includes selecting the recommended document for the portable terminal, further from at least one past document included in the history information of the other portable terminal.

8. The non-transitory computer readable medium according to claim 1, wherein:
the process further comprises
acquiring sound information including a voice, and
extracting a word by analyzing the acquired sound information;
the document attribute information includes a word associated with each of the electronic documents; and
the selecting of the recommended document includes selecting the recommended document for the portable terminal from the plurality of electronic documents, on a basis of the extracted word.

9. A document recommending apparatus comprising:
a current position information acquiring unit that acquires current position information of a portable terminal;
a memory that stores place attribute information, a plurality of electronic documents, and document attribute information, the place attribute information being information in which positional information and an attribute of a place indicated by the positional information are associated with each other, the document attribute information indicating an attribute of each of the plurality of electronic documents;
a current position information analyzing unit that determines an attribute of the current position information on a basis of the current position information and the place attribute information;
a recommended document selecting unit that selects a recommended document for the portable terminal from the plurality of electronic documents, on a basis of the attribute of the current position information and the document attribute information; and
a display controller that causes information indicating the recommended document to be displayed on a display of the portable terminal.

10. A document recommending method comprising:
acquiring current position information of a portable terminal;
storing place attribute information, a plurality of electronic documents, and document attribute information, the place attribute information being information in which positional information and an attribute of a place indicated by the positional information are associated with each other, the document attribute information indicating an attribute of each of the plurality of electronic documents;
determining an attribute of the current position information on a basis of the current position information and the place attribute information;
selecting a recommended document for the portable terminal from the plurality of electronic documents, on a basis of the attribute of the current position information and the document attribute information; and
causing information indicating the recommended document to be displayed on a display of the portable terminal.
